(19) United States
(12) Patent Application Publication
(10) Pub. No.: US 2024/0104194 A1
(43) Pub. Date: Mar. 28, 2024

(54) METHOD FOR ASSOCIATING AN EXECUTABLE SOFTWARE PROGRAM WITH A COMPUTING PLATFORM

(71) Applicant: TAGES, Le Cannet (FR)

(72) Inventors: Gianni Santinelli, Santarcangelo di Romagna (IT); Vincent Lefebvre, Le Cannet (FR)

(73) Assignee: TAGES, Le Cannet (FR)

(21) Appl. No.: 18/257,913

(22) PCT Filed: Dec. 17, 2021
(86) PCT No.: PCT/EP2021/086393

§ 371 Date: Jun. 16, 2023

(30) Foreign Application Priority Data
Dec. 17, 2020 (FR) 2013520

(51) Int. Cl. G06F 21/53; H04L 9/08

(52) U.S. Cl. CPC G06F 21/53; H04L 9/0861

(57) ABSTRACT

The method for associating an executable software program with a computing platform includes: providing an initial software program, the computing platform in which the executable software program is executed, the computing platform comprising a trusted execution environment, means for generating a key for associating the software program with the computing platform, means for modifying the initial software program; employing the association key generation means to generate the association key; transmitting the association key in the trusted execution environment; employing the initial software program modification means to modify the initial software program using the association key; and obtaining a modified software program; executing the modified software program; executing at least one component of the independently provided or modified software program, which component requires the association key to be executed, in the trusted execution environment.

### FIELD OF THE INVENTION

The present invention relates to a method for associating an executable software program with a computing platform executing said program. This association carries out an attachment of the software program to the computing platform on which it is executed. This association—or attachment—authorizes the execution of the software program only on the platform to which it is associated/attached, and not on other platforms, for example similar or identical platforms.

It relates, in particular, to a generic method for modifying a software program, constraining its execution in a single execution environment. Once the association has been carried out, the method controls in a precise manner the execution of the software program located on the computing platform identified. The modification of the program involves both a defense for a use on another platform and a means for slowing down or prohibiting its analysis and its modification, according to the embodiments explained. The method according to the invention thus further constitutes de facto a method for protecting the software program. It allows de facto to generate a different version of a software for each of its deployments and no longer to deploy a single version of a software for all of its deployments. This differentiation allows to put in place a remote control of each deployment in a granular manner and also to establish a unique protection for each of its deployments.

The method according to the invention aims to restrain the dissemination of software programs for a use without the right or for their use outside of a trusted perimeter defined by its operator. It allows to recover, remotely, an identification of the machine that executes the software, in particular during the execution of this software program.

The method also allows to modify the protection by the sending of a new protection profile to the machine identified in a unitary manner that executes the software program.

Finally, the method allows to forbid or to stop remotely the execution of a unique instance of the software program associated with a computing platform identified in a unitary manner for various reasons such as the energy expenditure, the expiration of the rights to use granted by the operator, the existence of risks associated with the use of the software, “cyber” attacks taking advantage of the execution of the software program.

### PRIOR ART

The need to create an attachment, or an association, between a software program and its execution environment is a response to the old problem of avoiding the cloning or an unauthorized use of said software program. This need satisfies the necessity for a developer of software programs to control and to limit the use of their software program to maintain the revenue drawn from the sale of licenses of this software program.

In addition to this old and still current need, new challenges in computer security are appearing. In particular, in the deployments putting in place a plurality of nodes of execution of a software, for example in telecommunication networks, it is required to ensure that a particular and unitarily identified software is executed on a platform or a computing architecture itself identified in a unique manner. Having a certainty that a unique software is being executed on a machine identified unitarily, there is available, in addition to this guarantee, a remote control that this software program is indeed being executed on the one hand, and, on the other hand, if necessary, the taking control thereof can be resorted to. In particular, this targeted remote control allows to contain computer attacks by reducing the possibilities of reuse of all or a part of the software, in particular in the case of massive deployments of this software program.

Various solutions are known from the prior art in order to carry out the above associations.

These can be first of all rights management solutions (Digital Right Management or DRM) routinely used in the video game field, intended for computers of the personal type and which can be applied to other software fields for personal or professional use.

These “DRM” solutions are proposed to video game software program publishers, who carry out the attachment of the game software program on the machine of the player. This attachment—or association—is carried out by implementing the method according to which a rights verification routine is inserted into the game software program, possibly at several locations. The instructions of this routine are automatically inserted into the instructions of the original video game program. The routine accesses an activation token and the identification data of the machine. These two pieces of data are required for the rights verification routine to approve or deny the rights. The approval leads to the continuation of the game. The reception of the activation token requires a step of online activation as explained below.

Finally, this can be an activation step involving delivering an activation token. Once the game software program is initially installed on the machine, upon the first startup of the game software, a step of activating the license is started. It consists of an exchange between the machine of the player and a remote server and comprising in the upstream direction, namely from the machine of the player to the server, elements for identification of the machine and the serial number of the video game, which was delivered to the player after a purchase online. The license activation server verifies the residual rights associated with the serial number and, if necessary, delivers a license activation token in the downstream direction, and which results from the identification data of the machine of the player.

During the running of the game and upon reaching the rights verification routine, the latter verifies that the data of the machine is indeed associated with the activation token and, according to the result of the test, authorizes the continuation of the execution of the game, or interrupts its startup or, if the test is carried out during the game, interrupts its execution. Thus, the transfer of the activation token onto another machine is useless.

The attachment of the software program to the machine is relative in the sense that it is carried out by an external piece of data, namely the activation token. Each token is associated with a single machine. There are as many tokens as different machines but a single game software operating on all the machines. This software integrates a rights verification routine that allows to move forward in the game.

The verification routine requires both pieces of data to approve the use rights: the activation token, which must be present at a known memory location, and the various identification data that it recovers at each test. This data is recovered during each execution of the rights approval routine, during the game.

The shortfalls of this method are known. The identification data of the machine results from the execution of a binary instruction called CPUID, which recovers the data characterizing the capacities of the processor and other data such as the memory partition of the operating system and/or the version of the operating system.

All of this identification data delivers neither unicity nor stability. The more it is sought to refine the identity, the more there is a risk that certain data used will have varied between the activation step (exchange with the remote server) and the verification of the routine. Thus, the non-unique identification allows for simple hardware configurations to not allow to discriminate two machines. This lack of precision is used by the attacker.

More seriously, it can be relatively easy to modify the rights verification routine by circumventing the instructions having the goal of collecting the identification data so as to always deliver those expected and corresponding to an activation token previously recovered. The modified software, at its activation routine, is associated with the token used during the modification. The association is usable on all the machines and the rights management routine is ineffective. It should be noted that this method involves producing the modification at minimum leading to the result, leaving the rights verification routine but with a modification of the latter in order for it to use incorrect data. Another method involves eliminating this routine entirely. In order to make these operations complicated to carry out, techniques for obstructing the modification—detecting and blocking correct operation—are disseminated in an equitably distributed manner, in a large number and camouflaged. None of these techniques forms an absolute shield. Thus, the attacker will favor the changes at minimum to the rights management routine, an approach that reduces inasmuch their work of circumventing the obstacles to the advancement of their work by reducing the number thereof. Finally, to protect their routine and reinforce their defenses, the provider of a DRM solution implements, in addition, code obfuscation techniques, with the goal of making the analysis more complex. However, these techniques only slow down the attacker and raise the level of effort required to reach their goal.

These can further be other DRM solutions, which work by attachment to an external device.

These solutions are solutions intended to secure the use of applications of the professional type, in particular when they are distributed in a large number, and are distributed with hardware devices delivered to the users. The operation is simple: the application software program requires, in its operation, an element stored in this hardware device. In a rather common manner, the technique involves the program, precisely the textual section of the program, being encrypted in the file. An automatically installed module external to the program has the goal of decrypting the encrypted part of the program using a key stored in the external device.

The shortfalls of these other solutions are known. On the one hand, the exchanges between the module and the external device are capable of being spied on and the key can be recovered. More seriously, it is observed that as soon as the encrypted part of the program is decrypted, the program is then loaded into memory but without attachment to the machine. An attacker can recover, by one or more dumps of the memory, the content of the memory pages corresponding to the program, and reconstitute the program no longer comprising rights management. Moreover and finally, it should be recalled that the attachment carried out is not produced on the execution environment, that is to say the machine on which the program is executed, but on the presence of an external device. The latter is mobile from one machine to the other, which confers a transportability of the license. Indeed, the right to execute the program on a single machine is bought without this machine being identified.

Moreover, it should be noted that the hardware trusted execution environments, designated by TEE hereinafter, are devices associating modifications of design on the processor and specific instructions for using them. They are offered by processor suppliers such as Intel™, AMD™, ARM™ to name the most well-known ones, or middleware providers such as such as Trustonic™, Samsung™, Huawei™. The latter provide a software layer allowing to facilitate the use of the hardware devices of the former. By implementing an encryption of the memory pages contained in these execution environments, they provide an additional protection: the software and the data that reside therein are protected in reading and writing in a certain manner. This data and its processing carried out by the software that resides therein exclusively remain private and cannot be modified including by the operating system. Even when the attacker has available all the rights to access the computing architecture comprising a TEE, they cannot access the contents of the TEE.

In general, it will be considered below that a trusted execution environment is a hardware and/or software solution allowing to execute code and place therein data arbitrarily selected by the user and delivering a protection in terms of privacy and integrity of this software and data with respect to any element outside of this content. At present, TEEs integrate this definition by associating modifications of hardware design at the processor and specific instructions for activating them.

The following technical elements characterizing TEEs should be noted in particular in the perspective of a limited execution of a software on an identified machine.

In general, it will be considered below that a trusted execution environment is a hardware and/or software solution allowing to execute software and the data that it processes selected by the user and delivering a protection in terms of privacy and of integrity of this software and processed data with respect to any element outside of this perimeter. At present, TEEs integrate this definition by associating modifications of hardware design at the processor, microcode installed on the processor and specific user instructions for activating them.

These TEE devices do not confer identification of the computing architecture. Thus, any machine having available such a TEE can be the host of the private execution and integrates a software duly prepared for this purpose. This indistinguishability is a characteristic of trusted execution environments. A remote attestation mechanism allows a remote verification of the integrity and of the authenticity of the software load inserted into the TEE called Trusted Computing Basis (TCB) and in addition to the physical reality of the TEE. This remote attestation mechanism does not allow to identify the computing architecture in a unitary manner. However, upon their manufacturing, these TEEs have available unique cryptographic elements. Yet these cryptographic elements cannot exit the TEEs. They cannot therefore be used for the necessary modification of the program necessary to create the dependency with these elements. The only way to be able to identify a TEE, and the computing architecture that supports it, in a certain manner is to inoculate via a secure channel an identification key that is known a priori (by having generated it) and that is placed and used in the TEE. Finally, it can be considered that in addition to the hardware TEEs as explained above and directly associated with the routine processors, a hardware TEE can also take the form of a connected physical module distinct from the processor of the platform. This module can in particular be advantageously built around a processor of a type different than the platform and/or be designed for partitioned computing specific to the onboard systems integrating security measures for access to and the modification of the memory.

Another particularity is that the security guarantees in terms of privacy and integrity of the content of TEEs do not solve one of the major problems of computer security: the exploitation of vulnerabilities. The program inserted into a TEE, if it has software vulnerabilities, is just as attackable inside a TEE as outside. What's worse, an exploitation of vulnerability present in the TEE will be undetectable, which makes it more critical. The search for vulnerabilities in the software program can favorably be undertaken before the software program is integrated into the TEE where it will therefore be protected in terms of privacy and integrity. Thus, it is recommended, in particular by Intel™, to reduce the size of the TCB, that is to say size of the software load, to the strictly necessary, that is to say to only the security functions of a program.

Moreover and, in particular, for the most emblematic of the TEEs, the SGX™ technology from Intel™ prohibits calls to the operating system produced inside the TEE. The CPUID instruction allowing the identification of the machine cannot be executed therein like one may have been tempted to do. It is thus observed that the rights management routine as described above (case of the video game DRMs) cannot take place in extenso in a trusted environment, in particular of the type of the Intel™ SGX™ enclave.

It is observed that the use of a TEE, in particular with the SGX™ technology from Intel™, requires a security analysis, a precise definition of the content (delimited and restricted security part) and of the modifications of the software program at the source code (elimination of the system calls). The various embodiments of the invention are based on this operational requirement. All require having available a module that is executed in the TEE. It will be sought to delimit at minimum this contour over a perimeter that it will be sought to make constant as far as possible.

Moreover, it should be noted that the parts of the program, which are executed in the TEE from Intel™, must result from a specific compilation (SGX mode). They give rise to the creation of a fixed specific file that cannot be modified during its execution. However, as a parameter or variable, a piece of data can be delivered to this program by coming from the outside. The execution order specifies the program and the piece of data that it must use. It is thus observed that there is flexibility in the data and a total rigidity in the program intended for the TEE. Certain embodiments of the invention take advantage of this difference, by the use of the principle of code interpretation to transform instructions of a program into data and have available the flexibility of the data to execute, via the interpretation, various programs in the TEE.

Moreover, the code interpretation model routinely designated as virtualization is known. This principle involves producing an abstraction of the program. The latter is thus transformed into a piece of data called bytecode which requires another software program consisting of multiple interpreters (all of which form a virtual machine) capable of interpreting (that is to say executing) the bytecode.

The TEE devices allow to establish secure transmission channels. These links allow in particular to inoculate in these environments a unique identification element that will thus be totally secure since it will be inaccessible for reading or for writing.

Finally, it should be noted that the mode of use called Protected Control Loader of the SGX™ technology from Intel™ delivers a protection in terms of privacy of the software program before it is loaded into the TEE (which complicates the search for vulnerabilities and the theft of intellectual property). The program, or rather the part of the program duly delimited to be integrated into the SGX, is encrypted on the outside and is decrypted and executed in an SGX enclave.

Finally, techniques for controlling execution of a software remotely are involved.

Indeed, techniques allowing to remotely interfere with the execution environment of a software are known. These techniques allow in particular to stop the computing architecture and its execution environment. In the case in which the computing architecture or the virtualized execution environment execute a plurality of distinct computer programs, this solution only offers an overall control by treating all these computer programs in the same way. In particular, if a stoppage is considered, all the computer programs that are located therein are stopped without distinction. Moreover, this solution is based on strong trust in this control means and in the mechanism for identification of the computing architecture.

Via the technique that falls under the design and the development of the software program, the software can be designed for its remote control. This technique does not allow a priori to identify in a certain manner the instance of the computer program in a plurality of deployments of this computer program. Moreover, this technique is not applicable onto a software program executable in its state of binary file ready for deployment.

There is the technique of modification of an executable program for its remote control. This technique involves adding one or more execution control routines communicating with a remote control system. This technique can be associated with a means for delivering an identification of the computing architecture. This identification is based on an identification technique similar to that used in the field of PC (Personal Computer) video games, based on the CPUID identifier of the processor or any other relevant information (IP address, GPS coordinates, etc.). In the same way as the technique for identification of the video game, the identification of the computing architecture cannot be certain.

The last two techniques do not allow to defend against the circumvention techniques implementing an inverse analysis then modification of the execution control modules. An inversion of the value of the tests is still possible (before the next test of integrity of these modules if it is scheduled) when the module is located in the normal execution environment.

Finally, the current schema of deployment of a software is to produce a unique version for each of its deployments.

### SUMMARY OF THE INVENTION

Given the above, a problem addressed by the invention is to provide mainly a method for strong association between a software program and its platform, namely machine identified in a certain and unique manner. The intended solution combines a method for certain and unitary identification of an execution machine and the creation of a dependency as high as possible between the software program and this unitarily identified machine.

The solution uses the concept of trusted execution as well as the generation of a plurality of different versions of the software. In addition, the present invention offers the possibility of implementing a remote and targeted control of the execution of the software program.

The object of the proposed solution of the invention to this problem posed is a method for associating an executable software program with a computing platform comprising the following steps:
providing an initial software program;
providing the computing platform in which the executable software program is executed, said computing platform comprising a trusted execution environment;
providing means for generating a key for associating the software program with the computing platform;
providing means for modifying the initial software program;
the means for generating the association key generate the association key;
the association key, or a key derived from said association key, is transmitted in the trusted execution environment;
the means for modifying the initial software program modify the initial software program by using the association key, or the key derived from said association key, and a modified, differentiated and unique software program is obtained;
the modified software program is executed in the computing platform;
at least one component of said independently provided or modified software program is executed in the trusted execution environment and requires, for its execution, the association key contained in this trusted execution environment.

Advantageously: —the means for modifying the initial software program modify functions, components, instructions and/or blocks of instructions of the initial software program, including the data structures, by using the association key, or the key derived from said association key, and a modified software program is obtained, differentiated and unique for each of its deployments; —the component is at least one component of the modified software program; —the initial software program is modified by at least partly encrypting said initial software program and by grafting to said initial software program a routine for loading a module for decrypting the at least partly encrypted initial software program, said routine being executed at the beginning of the execution of the modified software program, the decryption module being disposed in the trusted execution environment, and using the association key to carry out the decryption; upon startup of the execution of the modified software program, the loading routine, by a call to the decryption module, transfers an execution flow to the decryption module and delivers to it an encrypted content of the initial software program; the decryption module decrypts said content and sends it back to the loading routine which installs unencrypted instructions of the initial software program in memory and transfers the execution flow onto a first instruction; —the software program is not encrypted in its entirety but over parts of said software program; and the modified software program comprises, for each encrypted part, a loading routine which, during the execution of the modified software program, by a call to the decryption module, transfers the execution flow to the decryption module, by delivering to it a content of the encrypted part; —the initial software program is modified by intercepting jumps or branches in said program or functions of its external dependencies, and pointing to components identified by their address or by their name, by a branch or call to the branching module which is located in the trusted execution environment and which requires the association key to return addresses and/or names of functions as they appear in the initial software program; —functions, components, instructions and/or blocks of instructions of the initial program are modified by a transcription of these elements into bytecode and present in the modified software program in an encrypted state; a transfer routine located before each of the modified elements is provided and a module for interpretation of bytecode housed in the trusted execution environment and which requires the association key to decrypt the bytecodes then interpret them is provided; during the execution of the modified program, upon reaching a modified component, the transfer routine delivers to the interpretation module the encrypted bytecode; and the interpretation module decrypts the bytecode, interprets it and delivers a result in return to the transfer module which then transfers the execution to a first instruction of the next component of the non-modified initial program; —functions, components, instructions and/or blocks of instructions of the initial program are modified by at least one insertion of a routine for testing presence of the association key and the modifications to make it so that these functions, components, instructions and/or blocks of instructions are executed in the trusted execution environment; upon execution of the modified software program, when a modified component, instruction and/or block of instructions are reached, the execution of the program switches to the trusted execution environment and comprising at least one test of presence of the association key for or during its execution or the sending of a message of error or for stopping the program; —an execution control routine communicating with a remote centralized management-control system is added into a software component that is executed in the trusted execution environment; the control routine emits proofs of execution marked by the association key, or by a key derived from said association key, thus allowing to deliver a proof of execution identifying in a unique manner the software-computing platform association and receives messages for maintaining or stopping execution, intended for one or more computing platforms by one or more association keys or derived keys; by comparison to its own key or derived key, the execution module executes the message for maintaining or stopping execution or ignores it; —upstream and downstream communications between the remote centralized management-control system and the computing platform are made unintelligible to third-party instances; —the computing platform comprises a server for generating association keys and/or an association server modifying the initial software program and/or a centralized management-control system, said servers or system being formed by software programs executed on said computing platform and potentially as modules of the operating system of the platform; —the computing platform comprises a server for generating association keys and/or an association server modifying the initial software program and/or a centralized management-control system, said servers or system being formed by software programs that are executed in trusted environments and potentially as modules of the operating system of the platform; —the software programs are modules of the operating system of the computing platform, potentially encrypted before their loading into the trusted execution environment; —the transfer of the initial program uses a secure communication channel intended for the trusted environment; —the association server produces a signature associated with the data transferred to the module located in the trusted environment during the execution, this signature allowing to filter by a previous verification of the authenticity of this data and thus of the execution requests to the module; and —the association server receives an order for modification of the program by the centralized management-control system and corresponding to the version of the program associated with the unique platform.

### BRIEF DESCRIPTION OF THE DRAWINGS

The invention will be better understood upon reading the following non-limiting description, drafted with regard to the appended drawings, in which:

FIG. 1A presents the general principle of the invention and its two phases of before and during the execution of the software program. It is noted that the parts shaded in gray are optional. Indeed, it is possible to only have a single (first) access to the module located in a TEE and, in addition, not have an execution control routine.

FIG. 1B presents the implementation of the solution according to the invention from a practical point of view and thus of the various interfering hardware and software components. In particular, the key server, the association server (which modifies the original software program) and the execution environment of the modified program comprising in particular the TEE (trusted execution environment) are visible. It is noted that the association and association key servers can be combined into a single server or computer program.

FIG. 2A shows the first embodiment in which the decryption of the “text” section of the software is produced in the TEE, the software, once decrypted and ready for execution, is executed in the normal execution part.

FIG. 2B presents the second embodiment in which the control stream of the program is orchestrated by a module installed in the TEE (and which depends on the key for the production of these calculations). This module calculates the addresses of each jump from block to block.

FIG. 2C presents the third embodiment wherein functions are extracted (in light gray), transformed into bytecode (interpretable by the interpreter located in the TEE), and then encrypted with the association key. The interpretation takes place only in the execution environment having available association key and housed in the TEE.

FIG. 2D presents the fourth embodiment in which certain functions selected to be executed in the TEE are previously modified by the addition of an epilog or conditional stoppage of the function which verifies the presence of the key. The presence test engenders the normal execution or the termination of the function. It is noted that this epilog or conditional stoppage function is the component allowing to control the execution remotely. Indeed, in the epilog, a routine for transfer to a remote computer system for proofs of execution associated with the association key can be added. The conditional stoppage module can also be enriched with a routine communicating with a system for recovering targeted orders for stoppage of the program.

FIG. 3 illustrates the operation of an execution control with upstream and downstream messages between the centralized management-control system and the execution control routine. It is observed that the execution control routine is located in the trusted execution environment (TEE) and uses the association key in the sending of proof of execution and of identification or the validation of an order for maintaining or stopping coming from the centralized system. The latter has available a database comprising all the association keys (which corresponds for a given software to the various instances installed). It receives this information from the separate or integrated (into the centralized management system) key server.

### DETAILED DESCRIPTION OF THE INVENTION

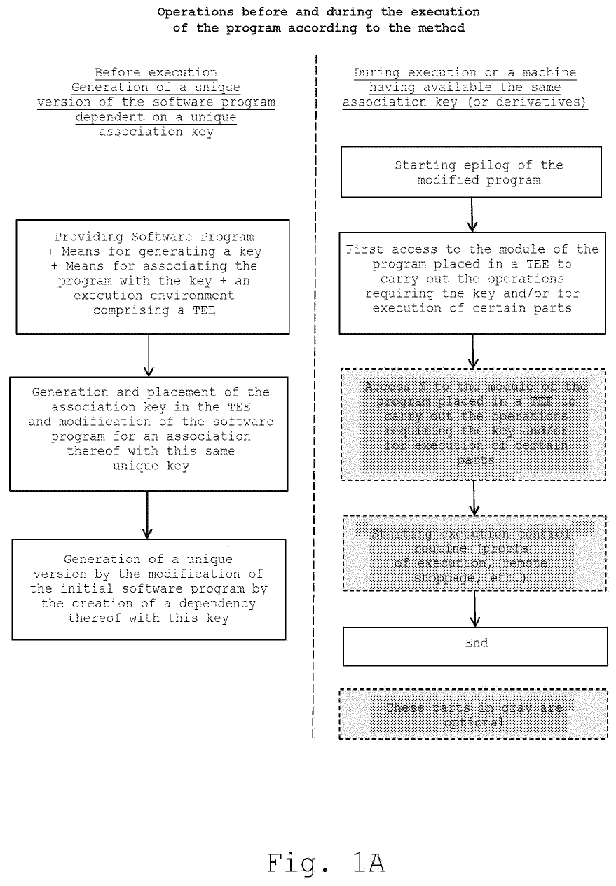

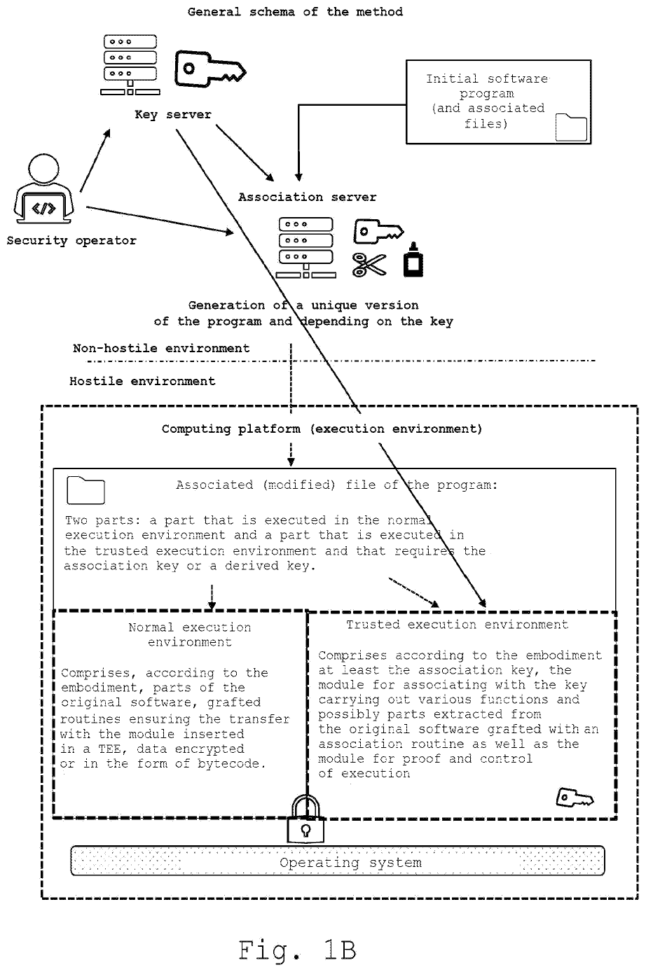

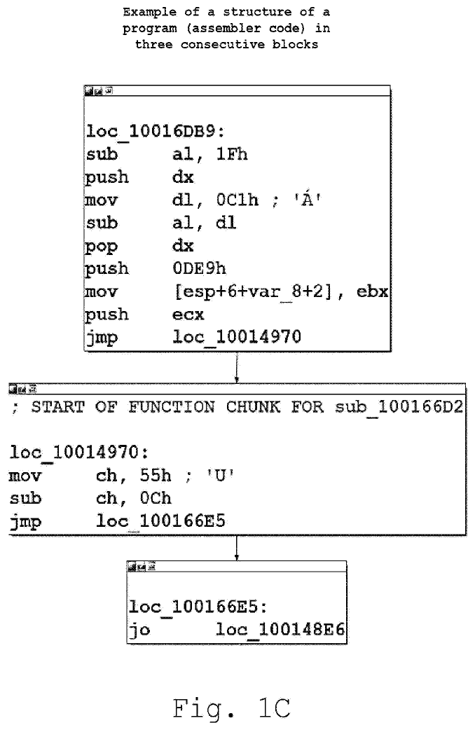

The method of the invention is implemented by computers. Figure LA illustrates its general principle. FIG. 1B illustrates this same principle, on a practical level.

According to the invention, a computing platform is provided. This computing platform is also designated, in the present application, by computing architecture or execution machine. The computing platform is a platform having available one or more servers having available various physical resources and, in particular, one or more processors, as well as associated random-access memories, one or more storage memory spaces for example of the Flash or hard disk type, one or more trusted execution environments, all of this being managed by an operating system.

The computing platform is potentially located in a hostile environment and equipped with a trusted execution environment or secure execution environment.

According to the invention, a secure communication channel is established between the execution machine and a key server. By this channel, a key used to produce a dependency of a software program modified by an association server is inoculated in the secure execution environment.

The secure execution environment is an environment of a hardware and/or software nature. Advantageously, it is a hardware environment (TEE).

Via these operations, the software program cannot be executed, given the dependency created only on the execution machine possessing the association key. Indeed, the key inoculated on the execution machine and located in the trusted environment can be neither read nor copied to be placed on another computing architecture.

In the computing architecture, the key server is located in a non-hostile environment. It provides a software program for generating identification keys.

In the computing architecture, the association server is located in a non-hostile environment. A software for associating binary programs with an execution environment is provided. A link with the key server computing architecture is established for the recovery of keys used for the associations. An initial software program is provided. This software program is modified by the association server. A modified version of the initial software program is thus obtained by the elimination, the addition or the replacement of its instructions or numerical values and by the split into two parts being executed respectively outside of and in the trusted execution environment. One of the two parts is generated uniquely in a bijective relation with the association key or a key derived from this association key and the part being executed in the trusted environment. The association server uses one of the keys provided by the key server to create a dependency with this key for the execution of this modified program. During the execution of the modified software program, the execution of the part being executed outside of the trusted environment is conditioned and dependent on the execution of the part being executed in the trusted environment.

In practice, the association server and the association key server can be two computer programs executed on the same computing architecture. The two functions of modification of the computer software programs and of generation of keys can also be two functions of the same software program. Possibly, these two programs can be executed directly in a TEE, which allows to deploy these elements in a hostile zone. These two functions can also become modules offered directly by the operating system of the platform.

The creation of this dependency with a key engenders the generation of as many different versions of computer programs coming from the initial software program as there are different association keys and thus different deployments for this software program. Each version created is different and requires a unique association key to be executed.

The initial software programs are intended to operate on multiple software programs, for example multiple personal computers, workstations, servers, game consoles, various computing units, mobile telephones. These initial pieces of software are generally the same. However, the association key is unique. The program modified by using the association key is unique. The association itself between the software program and the computing platform is thus unique.

Advantageously, the dependency of the software program on the key must persist throughout the entirety of its execution as opposed to an ephemeral dependency for example such as occurring only in the startup phase of the program.

A first embodiment involves the program being encrypted and its decryption being carried out in the trusted execution environment by the key then, once decrypted, sent back to the normal execution environment for its execution. This embodiment only engenders a temporary dependency on the key, only at the moment of its decryption. Once decrypted, the program installed in an unencrypted manner in the normal execution environment can be copied and executed on another machine. This requires, for the attacker, to have available the control of the memory of the execution environment. In the situations in which it is impossible, for practical reasons, to have available the control of the memory of the execution environment by the attacker, this first embodiment delivers the certainty that the program, which will not be able to have been copied once decrypted, is indeed executed on a machine identified in a certain manner. In the contrary case, by this first embodiment, since the program once decrypted can be recovered and transferred to another machine, its execution on this machine is no longer certain.

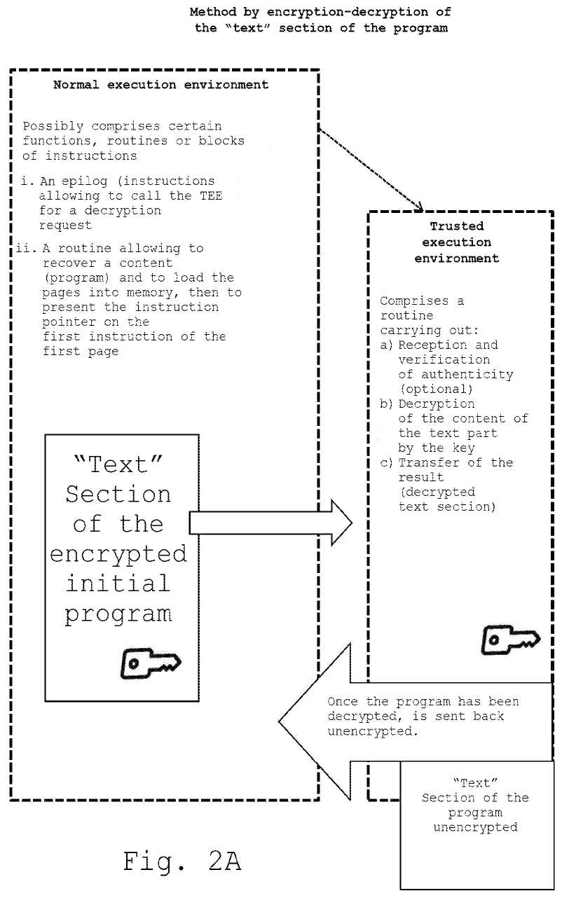

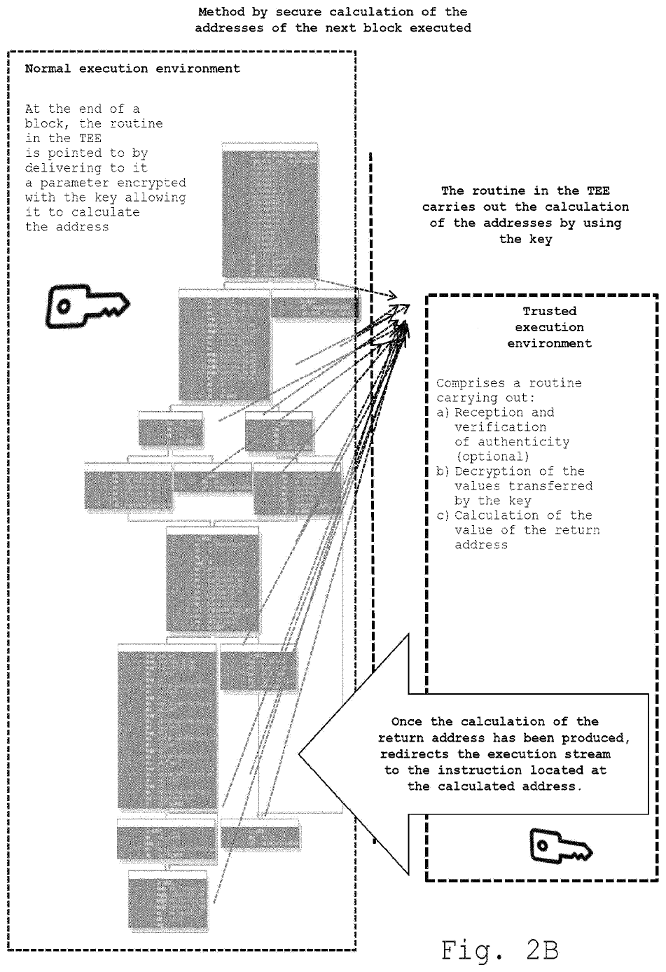

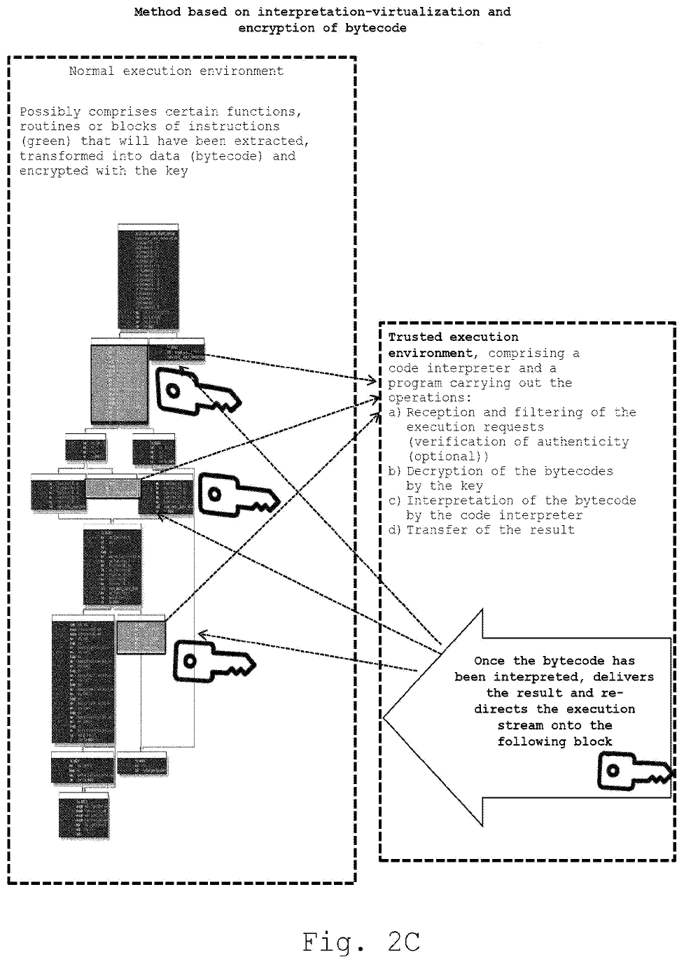

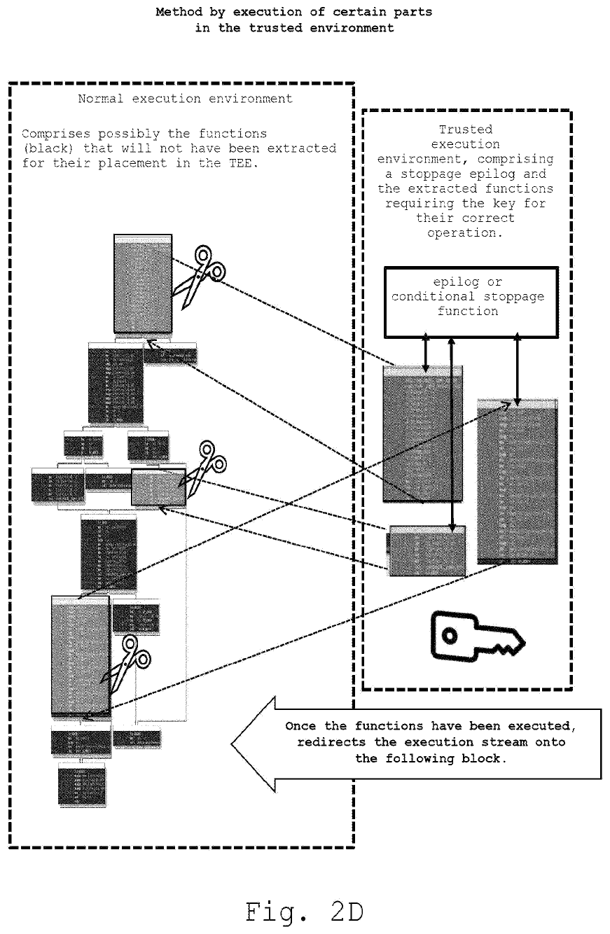

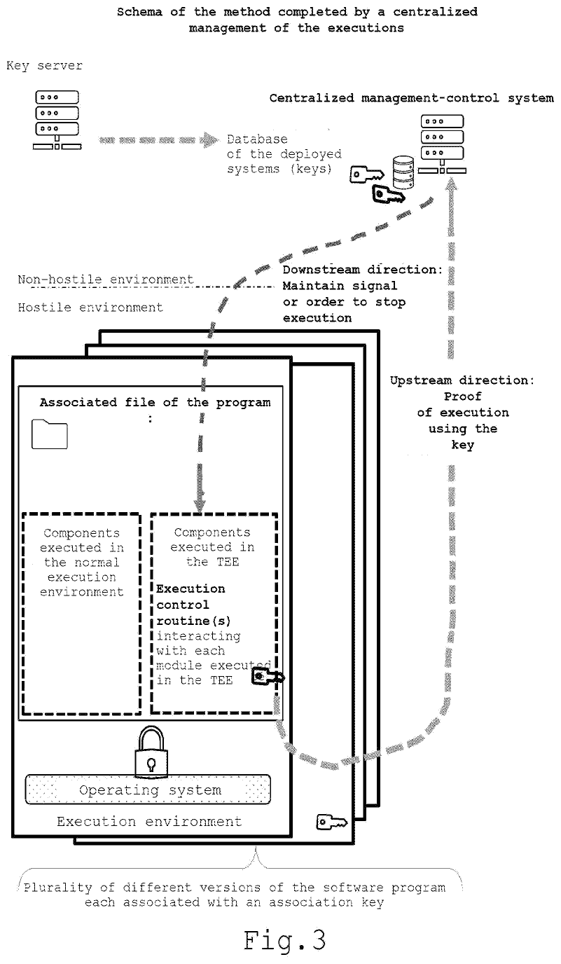

In a second embodiment, the dependency of the software program on its key can result in a transformation of the program by modifying the jump addresses of the program to its various modules or blocks of instructions or to external dependencies so that each jump points, after modification, to an address calculation module inserted into the secure execution environment and which uses the previously inoculated key to do this. The dependency on the key is maintained as long as it is necessary to carry out a jump to a block of the program or an external dependency. It can be considered, from a point of view of security, that a complete and exhaustive execution of the program, representative of all the possible cases and thus of the passage in all its branches of execution, allows the attacker to recover all the addresses of the jumps by dynamic tracing of execution (by using a debugger) and thus to be able to reconstruct a program stripped of the dependency on the address calculation module and of the key. It is noted that for reasons of ease and readability of the drawing, FIG. 2B only covers the transfer of control for the calculation of the addresses of the blocks of the program and not to the external dependencies. Finally, this principle applies to all the management instructions of the control graph of the program (conditional jumps, unconditional jumps, routine or function calls, return, etc.).

In a third embodiment, extractions of instructions can be carried out in order to place them in an encrypted manner in the secure execution environment. To do this, a code interpreter in the TEE is used and a piece of data corresponding to the bytecode of the extracted parts and which will have been encrypted with the association key is transferred to the TEE. In order to be executed, this data structure (the bytecode) requires the key for its decryption then execution via the interpreter. The dependency on the key lasts as long as upcoming instructions of the program will have been thus transformed into bytecode then transferred into the TEE. From the point of view of security, the reconstruction of the initial program is never possible in a certain manner since the extracted instructions previously transformed into bytecode and encrypted are only decoded inside the trusted execution environment, sheltered from any outside access.

In a fourth embodiment, a static analysis of the code is produced to extract therefrom certain functions suitable for execution in the TEE (that is to say satisfying criteria on the content of the processing carried out in particular without system calls while having available a secure nature). These functions are modified to add thereto a prolog routine upstream of their execution verifying the presence of the association key. If the test is affirmative, the rest of the instructions are executed. If the test is negative, the prolog directs the execution stream to the epilog of the function or more simply to a stoppage or the transmission of an error code to the program, short-circuiting the processing of the function. Thus, only the execution environments having available the association key allow the private execution of the functions exported into the TEE. It is noted that this epilog control function can also be called at any other suitable moment in the execution of the function thus moved and not necessarily upstream of the execution stream. In addition, to avoid the recovery of the code executed in the TEE (that is to say of the selected functions), the use of the encryption of these functions before their loading into the TEE is preferred (for example by the use of the PCL mode of Intel™ SGX™).

Optionally and in all the embodiments described above, it is always possible to graft upstream of the modules executed in the trusted environment an epilog for filtering the requests by a verification of authenticity. The latter can be carried out advantageously and for example by a signature produced in the association server. This signature is produced by an asymmetric encryption (use of the private key for the encryption) and a hash of the piece of data transferred. Upon reception of the request and of the signature, the epilog can carry out the operations of verification of authenticity (origin and integrity) of the requests (and their data) before processing them.

Finally, once the association has been created, a control routine can be automatically inserted into the module or the components inserted into the TEE. This routine can for example transfer to a remote centralized management system a proof of execution of an associated program marked with the association key. Thus, the proof that a unique (modified) version of the initial software, installed on a platform identified uniquely, has indeed been executed is sent to a centralized management system. Moreover, this control routine can also be used to receive an order to interrupt the execution of the program.

To summarize, the invention delivers a certain and unitary identification of a computing architecture, various modes of association between a software program specifically generated in a unitary manner for a computing architecture identified in a unique manner and a targeted control means for the execution of this program.

The invention thus relates to a method for associating an executable software program with a unique computing architecture. The object of this method is to ensure that a software (or a plurality of instances of this software) is executed only on the computing architectures previously identified by a differentiation step. The initial software program is modified in order to create a dependency on these machines. This dependency is based and materialized on a unique association key or a key derived from the latter and which is used both for the identification of the computing platform and for the modification of the software program.

The differentiation step involves inserting a unique association key (or a derived key), generated by an association key server and which is housed through a secure communication channel in the TEE trusted execution environment. Protected in reading and in writing at this location, this key is the element which allows the differentiation of the computing architecture.

An initial software program is modified for its association by means based on techniques associating encryption, the rerouting of the execution flow control into a module located in the trusted environment, code interpretation, the rewriting of sequences of instructions for their execution in a trusted execution environment, the insertion of a routine for verification of presence of the association key, the insertion of an execution control routine.

In general, the method according to the invention comprises the following steps according to which: —an initial software program, means for associating said software program and means delivering an association key are provided; —a static analysis of the initial software program is carried out, said static analysis comprising an identification of components of said software program; —the initial software program is modified in order to obtain a modified and unique software program, depending on an association key (or a derived key) for the correct execution of its components. This modification engenders both modifications in the software being executed in the normal environment and the creation of software components being carried out in the trusted execution environment in which the association key is located. This same association key (or a derived key) is inoculated in the trusted environment of the computing platform. Thus and at this location, the key cannot be extracted, read or modified. Generated in a unique manner, it also allows to uniquely identify the computing platforms.

During the execution of the modified program, the component(s) placed in the trusted execution environment have access to the key necessary for their correct operation. These components can in certain cases have been previously installed in the trusted environment, de facto not forming a part of the modified program.

The method allows to have available either a plurality of computing platforms having available the same association key (or a derived key) so that various instances of this software program can be executed on a plurality of computing platforms. In this case, a single version of the software program modified and associated with a key is created for a deployment on several machines.

The method also allows to only have available the association key (or a derived key) in a single computing platform. In this case, the method generates as many version of the modified software program, each associated with a different association key, as there are computing platforms for the execution of this software program.

Thus, the method according to the invention implements both a method for unification (if the execution of the software is contained in a single computing platform) or validation (if the execution of the software is carried out by a set of computing platforms) based on trusted environments and a method for modification of the computer programs to create a functional dependency on the element that is used for this identification or validation, the association key (or a derived key). The two steps (identification-validation of the computing platforms and modification of the computer program) both require the association key or a derived key. To simplify, a specific version of the program that requires a key for its operation and which is hidden in a trusted execution environment is produced. If this key has only been delivered in a single platform (and in its trusted environment) then this version of the program can only be executed on this single machine. This version of the program can then be controlled in a unitarily targeted manner. It is also possible, when the association server is present on the platform, to modify the software installed on this platform, including when the software is already deployed and in a unitary manner.

A first embodiment, described in FIG. 2A, involves encrypting the text section of an executable software program file. This part contains the various software instructions in assembler language and which will be loaded by the processor, when the time comes, into memory pages reserved for the execution of the program. In a certain manner, the processor is incapable of executing this program in this state. The previous decryption of the data structure corresponding to the encrypted text section is an unavoidable step before starting the software program. The encryption used during the modification of the program is connected in one way or another and regardless of the type of key used (symmetric, asymmetric) to this association key or a derived key. It is possible for example to encrypt the text section with a private key of a pair of asymmetric keys and use the public key for its decryption or in the same way, it is possible to use the same symmetric key in the steps of encryption and decryption of the software program. Regardless of the method of encryption (symmetric or asymmetric), the suitable key corresponding to the encryption is used during the modification of the program for its association and the suitable key (symmetric or asymmetric) is used in the trusted execution environment of the execution platform. In this embodiment, it should be noted that the program modified and executed in the normal environment can be likened to a program loader. This loader transfers its load (the encrypted data structure) and an execution order to the part of the program modified and placed in the trusted execution environment. This function only produces a decryption of the data structure by use of a key duly positioned in this same trusted execution environment. Once the decryption has been carried out, the result is transmitted to the loader which can then load into memory the decrypted instructions and start the execution of the program in the normal environment. Thereafter, the execution of the software no longer requires the key. An alternative to this decryption in a single block is to work by block of instructions, sub-function or function of the software program. The same method applies with a multiplication of the loading module which must be grafted just upstream of each of the components considered (function, block of instructions, sequence of instructions). In this first embodiment, the modification of the program involves inserting the loader(s) in the right place, creating the decryption module using the association key and placing it in an “enclave”, that is to say a software component duly compiled, dedicated and automatically loaded into the trusted environment, then finally creating the link between the loader(s) and the decryption module. This technique allows to reduce the software in the trusted execution environment to a single decryption module, identical for all the programs to be protected, thus reducing the complexity associated with the use of trusted execution environments. The software once modified consists of the residual initial program that is not encrypted, the loader(s) located in the correct place and the decryption module forming an enclave. This module can also be previously installed to the trusted environment and not be part of the modified software.

A second embodiment takes advantage of a technique of deviation of the control flow of the program. FIG. 1C presents a program part composed of three blocks of instructions and two jumps (the destination addresses of the jumps of which are perceived at the bottom of the blocks of the two upper blocks). FIG. 2B illustrates the general operation of this technique. The circumvention of the management of the control flow involves modifying these addresses into the address of a module located in the trusted execution environment. Each jump to another block is circumvented to the module that calculates and returns the addresses and for its calculations, it requires the association key. In this embodiment, the modification of the program for its association consists of the substitution of the jump addresses to point to the address of the module for managing the flow and the creation and the providing of this module for calculating the addresses requiring the association key, its specific compilation for its execution in the trusted execution environment. This technique allows to reduce the software in the trusted execution environment to a single module, identical for all the programs to be protected, thus reducing the complexity associated with the use of trusted execution environments. The software once modified consists of the initial software program from which all the addresses of jumps to blocks of instructions internal to the initial program have been extracted and of the module for managing the control flow compiled as an enclave. It is noted that for reasons of ease and readability of the drawing, FIG. 2B only covers the transfer of control for the calculation of the addresses of the blocks of the program and not to the external dependencies. Finally, this principle of taking control of the execution stream of the program applies to all the instructions influencing this graph (conditional jumps, unconditional jumps, routine or function calls located in external dependencies, return instruction, etc.). Each of these instructions can give rise to a transfer to the module for taking control located in a trusted environment.

A third embodiment takes advantage of the principle of code interpretation. FIG. 2C illustrates this embodiment. The modification of the program involves producing a static analysis of the initial software program, selecting certain blocks, functions or components. These components are then transcribed in an intermediate representation before being compiled to allow their execution or interpretation by a set of code interpreters forming a virtual machine or interpreter. These components transformed into bytecode are now data structures that can be transferred to the code interpreter placed in an enclave of the trusted execution environment. Before their sending, these bytecodes are in an encrypted state so that the interpreter requires the association key to decrypt them then interpret them (that is to say execute them). In the part of the program that is executed in the normal environment, grafts placed before each call of this interpreter (and the sending of the associated bytecode) are produced. This technique allows to reduce the software in the trusted execution environment to a single code interpreter, identical for all the programs to be protected, thus reducing the complexity associated with the use of trusted execution environments. This code interpreter is placed in an enclave duly created during the modification of the software program. By this embodiment, the modified software consists of the residual software (not transcribed into bytecode), the routines for transferring execution to the enclaves located in the main software and before the extracted parts and the enclave comprising the code interpreter. It is noted that without the encryption and decryption of the bytecodes, all the execution platforms having available a trusted execution environment could execute the modified software. However, via the encryption and decryption by the association key, only the platforms possessing the key can execute the modified program by the interpretation of its components transformed into bytecode.

A fourth embodiment involves on the one hand creating and placing parts that will be executed in the trusted execution environment for some blocks of the program. These extractions are produced on the one hand through an analysis of the sensitive nature of these parts (in terms of security) and, on the other hand, by analysis of the conformity to certain operating constraints and exclusion. The initial software program is thus modified for the automatic creation of these enclaves corresponding to these parts of the program. During the phase of generation of these enclaves, a prolog or a module for managing the association is produced that does not produce a test of presence of the association key (or a derived key) located in the same trusted execution environment and according to the result of this test triggers either the branching to the first instruction (or a duly selected instruction) or to the end of the program in the case of failure of this test. This method is more complex to implement since it requires producing an automatic generation of enclaves (and their compilation) corresponding to the various components selected.

It provides a security equivalent to the preceding method in the sense that the parts executed or interpreted (for the third embodiment) in the trusted execution environment are never recoverable for the attacker. The software once modified consists of the software program, the sequences of instructions calling the enclaves and the enclaves themselves. It is noted that without the grafting of the tests of presence of the association key in the enclaved components, all the execution platforms having available a trusted execution environment could execute the modified software.

It is noted that these embodiments are not exclusive. A “Russian doll” assembly having protections stacked on one another is possible. For example, the first embodiment can be implemented on the modified program corresponding to the second embodiment. Thus in addition to the interception of the execution flow control produced by the second embodiment, the modified software is encrypted in a complementary manner.

It is noted that the encryption mode equivalent or equal to the PCL mode from Intel can be applied in all the cases to protect all the software components as defined in the various embodiments and which are intended to be executed in the TEE so as to protect these software components when these software components reside outside (before their loading in the trusted environment).

For all these embodiments, the modified software program comprises at least one module located in the trusted execution environment. This module is produced and provided by the association server. Its role of association with the association key (or a derived key) can be enriched by an additional function ensuring the generation of proofs of execution or the control of execution remotely. Located in the TEE, this module can receive or emit with total discretion unintelligible messages with a remote control system. The techniques of encryption and of unicity of these signals can in particular be used to avoid the interception, the exploitation for the circumvention of their content and the reuse of a message to deceive the system. The techniques resolving the rupture of the telecommunication link can also be used. The link can thus function as an umbilical link between the centralized management-control system and the computing architecture executing the software program. The rupture of the link engenders the loss of reception of a message for maintaining the execution expected by the execution control module which thus makes the decision to stop the program.

The particularities of the execution control that the invention aims to provide use two differentiating technical facts: —the capacity to identify a platform in a unique manner (or a group of platforms having available the same key) by the unfalsifiable and private association key. The control is precise and targeted. Thus, the messages circulating in both directions going upstream are marked by this key or a derived key. —the total opacity of the control for an attacker having available the computing platform (and all the accesses and access privileges on the memory). The module is located in the TEE and carries out in total discretion and integrity its mission, using unintelligible messages which cannot be blocked (without blocking the software in its operation).

The solution also allows an embodiment in which all or a part of the functions carried out in a non-hostile environment by the key generation server and the association server producing the modifications in the software are directly carried out in the computing platform deployed in a hostile environment. Advantageously, it is ensured that these functions are integrated into the trusted execution environment of the platform. Also advantageously, the secure communication channel provided by the trusted execution environments with the outside is used to transfer the initial software directly into a trusted environment.

Finally, advantageously, the functions of key generation and association (by the modification of the program) are produced and offered by at least one module of the operating system of the computing platform. Moreover, advantageously, the association server of the program that integrates the trusted execution environment can communicate with the management-control server and receive orders to modify the program in order to meet a new security requirement, including when the program is already installed and operating, and to carry out this operation in a differentiated manner for each association key or a derived key. The association server can also carry out on its own initiative a modification of the program directly without receiving an outside order. This decision-making can in particular be motivated by the discovery of elements characterizing the speed of execution of the modified program or characterizing new security requirements or, finally, in order to implement a dynamic profile of the security.

1. A method for associating an executable software program with a computing platform, the method comprising:
providing an initial software program;
providing the computing platform in which the executable software program is executed, the computing platform comprising a trusted execution environment;
providing means for generating a key for associating the software program with the computing platform;
providing means for modifying the initial software program;
generating the association key, by the means for generating the association key, the association key being generated in a unique manner, and allowing to uniquely identify the computing platform;
transmitting the association key, or a key derived from the association key, in the trusted execution environment;
modifying, by the means for modifying the initial software program, functions, components, instructions and/or blocks of instruction of the initial software program, including the data structures, by using the association key, or the key derived from the association key, and obtaining a modified software program;
executing the modified software program in the computing platform;
upon execution of the modified software program, upon reaching a modified component, instructions and/or block of instructions, switching the execution of the modified software program into the trusted execution environment;
executing at least one component of the modified software program in the trusted execution environment, and wherein the at least one component of the modified software program requires, for execution, the association key contained in this trusted execution environment, or the key derived from the association key.

2. The method according to claim 1, wherein a unique and different modified software program corresponds to each uniquely identified platform.

3. The method according claim 1, wherein the trusted environment is a hardware trusted environment.

4. The method according to claim 1, wherein an entirety of the modified software program is executed in a trusted execution environment.

5. The method according to claim 5, wherein the trusted execution environment is located in a separate physical module attached to the computing platform.

6. The method according to claim 1, wherein:
the initial software program is modified by at least partly encrypting the initial software program and by grafting, to the initial software program, a routine for loading a module for decrypting the at least partly encrypted initial software program, the routine being executed at a beginning of the execution of the modified software program, the decryption module being disposed in the trusted execution environment, and using the association key to carry out the decryption;
upon starting of the execution of the modified software program, the loading routine, by a call to the decryption module, transfers an execution flow to the decryption module and delivers to the decryption module an encrypted content of the initial software program;
the decryption module decrypts the content and sends it back to the loading routine which installs unencrypted instructions of the initial software program in memory and transfers the execution flow onto a first instruction.

7. The method according to claim 6, wherein:
the software program is not encrypted in its-entirety but over parts of the software program; and
the modified software program comprises, for each encrypted part, a loading routine which, during execution of the modified software program, by a call to the decryption module, transfers an execution flow to the decryption module, by delivering to the decryption module a content of the encrypted part.

8. The method according to claim 1, wherein:
the components of the initial software program are modified by intercepting jumps or branches in the program or functions of external dependencies of the program, and pointing to components identified by their address or by their name, by a branch or call to the branching module which is located in the trusted execution environment and which requires the association key to return addresses and/or names of functions as they appear in the initial software program.

9. The method according to claim 1, wherein:
functions, components, instructions and/or blocks of instructions of the initial program are modified by a transcription of these elements into bytecode and present in the modified software program in an encrypted state;
a transfer routine located before each of the modified elements is provided and a module for interpretation of bytecode housed in the trusted execution environment and which requires the association key to decrypt the bytecodes then interpret the bytecodes is provided;
during the execution of the modified program, upon reaching a modified component, the transfer routine delivers to the interpretation module the encrypted bytecode; and
the interpretation module decrypts the bytecode, interprets the bytecode and delivers a result in return to the transfer module which then transfers the execution to a first instruction of the next component of the non-modified initial program.

10. The method according to claim 1, wherein:
the functions, components, instructions and/or blocks of instructions of the initial program are modified by at least one insertion of a routine for testing presence of the association key and the modifications to make it so that these functions, components, instructions and/or blocks of instructions are executed in the trusted execution environment;
upon execution of the modified software program, upon reaching a modified component, instruction and/or block of instructions, the execution of the program switches into the trusted execution environment and comprising at least one test of presence of the association key for or during execution of the modified software program or sending of a message of error or for stopping the program.

11. The method according to claim 1, wherein:
an execution control routine communicating with a remote centralized management-control system is added into a software component that is executed in the trusted execution environment;
the control routine emits proofs of execution marked by the association key, or by a key derived from the association key, thus allowing to deliver a proof of execution uniquely identifying the software-computing platform association and receives messages for maintaining or stopping execution, intended for one or more computing platforms by one or more association keys or derived keys;
by comparison to its own key or derived key, the execution module executes the message for maintaining or stopping execution or ignores the message.

12. The method according to claim 11, wherein upstream and downstream communications between the remote centralized management-control system and the computing platform are made unintelligible to third-party instances.

13. The method according to claim 1, wherein:
the computing platform comprises a server for generating association keys and/or an association server modifying the initial software program and/or a centralized management-control system, the servers or system being formed by software programs executed on the computing platform.

14. The method according to claim 1, wherein:
the computing platform comprises a server for generating association keys and/or an association server modifying the initial software program and/or a centralized management-control system, the servers or system being formed by software programs that are executed in trusted environments.

15. The method according to claim 14, wherein the software programs are modules of the operating system of the computing platform.

16. The method according to claim 14, wherein a transfer of the initial program uses a secure communication channel intended for the trusted environment.

17. The method according to claim 14, wherein the association server receives an order for modification of the program by the remote management-control server, and wherein the modification order occurs before or during execution of the modified program.

18. (canceled)

19. The method according to claim 14, wherein the association server independently carries out the modification of the program.

20. The method according to claim 1, wherein the trusted execution environment in which at least a part of the modified software program is executed and/or a server for generating association keys and/or an association server modifying the initial software program and/or a centralized management-control system is provided by a separate module connected to the computing platform.

21. The method according to claim 1, wherein the modified software program comprises at least one module located in the trusted execution environment, the module being produced and provided by an association server, which has a role of association with the association key, or a derived key, enriched by an additional function ensuring a generation of proofs of execution or a control of execution remotely.

22. The method according to claim 1, wherein an association server produces a signature associated with the data transferred to the module located in the trusted environment during the execution, the signature allowing to filter by a previous verification of the authenticity of the data and of the execution requests to the module.
